(19) United States
(12) Patent Application Publication
(10) Pub. No.: US 2010/0009156 A1
(43) Pub. Date: Jan. 14, 2010

(54) FILM

(76) Inventors: Hans Georg Daviknes, Stathelle (NO); Ole Jan Myhre, Porsgrunn (NO)

Correspondence Address: GARDNER GROFF GREENWALD & VILLANUEVA. PC, 2018 POWERS FERRY ROAD, SUITE 800, ATLANTA, GA, 30339, US

(21) Appl. No.: 12/519,016

(22) PCT Filed: Dec. 19, 2007
(86) PCT No.: PCT/EP07/11194

§ 371 Date: Sep. 17, 2009

(30) Foreign Application Priority Data
Dec. 21, 2006 (EP) 06256529.6

(51) Int. Cl. B32B 27/32; B32B 27/08; B29C 47/06; B32B 38/00

(52) U.S. Cl. 428/220; 428/523; 428/483; 264/173.16; 156/229

(57) ABSTRACT

The present invention provides a uniaxially oriented multilayer film comprising at least (i) an outer layer (B) and (ii) an inner layer (C), wherein said layer (B) (i) comprises a multimodal linear low density polyethylene (LLDPE), said layer (C) (ii) comprises at least one polymer component which has a Tm<100° C., and said multilayer film is in the form of a stretched film which is uniaxially oriented in the machine direction (MD) in a draw ratio of at least 1:3.

This invention relates to a thin film with excellent mechanical properties that can be formed into bags or sacks for packaging. In particular the invention concerns a multilayer film that is uniaxially oriented in the machine direction (MD) and especially to a laminated multilayer film that is uniaxially oriented in MD. Even at final thicknesses of less than 140 μm, the films of the invention exhibit excellent mechanical properties such as impact strength. The invention further relates to a film laminate for preparing a laminated multilayer film that is uniaxially oriented in the MD, as well as to a preparation method of said uniaxially oriented in MD multilayer film, particularly laminated film.

### BACKGROUND ART

Polymers are widely used in the manufacture of packaging for a great variety of materials. One typical application area is bags and sacks for the packaging of relatively lightweight material (e.g. up to 5 kg loads per bag).

Polymers are also used in the manufacture of packaging for higher material loads, e.g. bags and sacks for material weights up to 25 kg or even 50 kg. Such heavyweight applications place high demands for the packaging usable therefor, in particular good mechanical properties are required. Examples of high weight applications include heavy duty sacks, e.g. heavy duty shipping sacks (HDSS), and bags for the packaging of materials such as powders (e.g. cement mix), polymer beads, natural materials (e.g. compost, stones and sand) and waste materials.

Throughout the world, millions of tons of materials are transported and stored in sacks and bags, usually on pallets. Pallets enable moving and storing large volumes of materials and one pallet can be stacked on top of another. The resulting loads on at least some of the bags containing the materials is, however, extremely high, typically more than 1000 kg for larger, heavy duty sacks. It is crucial for the overall stability of the pallet, however, that none of the sacks deform or tear.

Sacks and bags for use in packaging, transportation and storage therefore need good mechanical properties, such as puncture resistance and certain tear resistance properties, with the exact demand depending on the end application area. Nevertheless, bags and sacks, especially heavy duty shipping sacks, have tended to be made of thick films to provide good mechanical properties.

Low density polyethylene (LDPE), linear low density polyethylene (LLDPE) or blends thereof are often used in packaging articles.

It is also known that to make polyethylene films having acceptable tensile strength for use in packaging, the film can be uniaxially stretched. At the same time, however, other mechanical properties, such as tear resistance in MD are typically compromised.

WO/064519 aims to address this problem and thus provide sacks having good impact strength as well as tear resistance. The sacks are made of a single layered, uniaxially oriented film comprising a blend of medium density polyethylene, LLDPE and optionally a third polymer such as an ethylene-vinyl acetate copolymer. The films exemplified in WO/064519 are typically 3 to 12 mils (about 76-304 μm) thick prior to stretching.

EP-A-0146270 to C-I-L Inc. discloses a heavy duty shipping bag having walls formed of cross-laminated uniaxially oriented polyethylene (which may be high density, low density or linear low density polyethylene) and inner walls of low density polyethylene (LDPE) to provide the film with the necessary mechanical properties including tear resistance and to facilitate heat sealing. The disclosed multilayer films are, however, still relatively thick, see, for instance, the examples which describe films having thicknesses of around 165 μm (2 layer film) and 240 mm (3 layer film).

EP-A-0184362, also to C-I-L Inc discloses a number of different films for the manufacture of sacks and bags including a laminated multilayer film comprising two layers of uniaxially oriented linear low density polyethylene (LLDPE) as outer layers and interposed therein are two layers of non-oriented LDPE. The layers of LDPE are present to prevent heat seal strength from being weakened. Film thicknesses of e.g. 165 μm for a 2 layer film are described.

At present, heavy duty shipping sacks generally have a thickness of, for example, 120-200 μm depending on the weight of material they are intended to contain. Reducing film thickness is, however, highly desirable due to material and thus cost savings.

There remains therefore a continuous need for alternative films suitable for making bags and sacks, and especially heavy duty shipping sacks, with an appropriate balance of mechanical properties depending on the desired end application area. There is particularly a need for further film materials with an excellent impact strength at lower film thicknesses.

### DESCRIPTION OF INVENTION

As used herein the terms LLDPE composition, znLLDPE composition, mLLDPE composition, LDPE composition and polymer composition refer to LLDPE polymer, znLLDPE polymer, mLLDPE polymer, LDPE polymer and polymer respectively. In a LLDPE composition, znLLDPE composition, mLLDPE composition, LDPE composition and a composition, the referenced polymer may be present as a single polymer (i.e. as a sole polymer) or it may be present within a mixture, e.g. in a mixture of polymers. Preferred LLDPE compositions, znLLDPE compositions, mLLDPE compositions, LDPE compositions and polymer compositions consist of LLDPE polymer, znLLDPE polymer, mLLDPE polymer, LDPE polymer and polymer respectively.

As used herein the terms LLDPE, znLLDPE, mLLDPE, MDPE, HDPE and LDPE refer to LLDPE polymer, znLLDPE polymer, mLLDPE polymer, MDPE polymer, HDPE polymer and LDPE polymer respectively.

### Multilayer Film of Invention

The present inventors have now found that a uniaxially oriented film which comprises a certain combination of linear low density polyethylenes (LLDPEs) and a polymer component, preferably an ethylene copolymer, having a Tm of 100° C. or less provides advantageous mechanical properties, namely at least an excellent impact resistance at film thicknesses considerably lower than the film thicknesses used in the prior art for such applications. Moreover, said mechanical properties are similar or even improved compared to those of thicker prior art films presently used in the packaging field.

Furthermore, the film of the invention has preferably a desirable balance between said impact resistance and one or both of the mechanical properties selected from tear resistance (determined in machine direction, MD) and creep resistance (determined in machine direction, MD). The property balance between impact resistance and one or both of said tear resistance and/or creep resistance can be optimized and adapted within the concept of the invention depending on the needs for the desired end application.

Thus the present invention provides thinner films with similar or even improved mechanical properties compared to prior art films for a wide variety of packaging applications.

In one preferable embodiment of the invention the uniaxially oriented in MD multilayer film has an advantageous property balance between the impact resistance and the tear resistance (in MD) at decreased film thicknesses. The film of this embodiment is highly suitable for packaging material of loads up to 5 kg, e.g. 2-5 kg. The creep resistance is often less critical in such lighter weight applications and can be optimized within the concept of the invention for the desired end use.

In another preferable embodiment the uniaxially oriented in MD multilayer film has an advantageous property balance between the impact resistance and creep resistance, as expressed in the machine direction at 23N load and at 23° C. temperature, at decreased film thicknesses. The film of this embodiment is highly beneficial for heavy duty packaging materials, e.g. loads up to 50 kg. Good tear resistance is also beneficial in such higher load applications, thus preferably the film of this embodiment has highly desirable balance between said impact, creep and tear properties and can be further optimized according to the intended end application. The highly demanding film applications include sacks and bags, e.g. heavy duty shipping sacks, HDSS, possessing the requisite mechanical properties, particularly possessing excellent impact strength as expressed with dart drop impact resistance.

Thus in a first aspect the invention is directed to a uniaxially oriented multilayer film comprising at least: (i) an outer layer (B) and (ii) an inner layer (C), wherein

said layer (B) (i) comprises a multimodal linear low density polyethylene (LLDPE),

said layer (C) (ii) comprises at least one polymer component which has a Tm≦100° C., and

said multilayer film is in the form of a stretched film which is uniaxially oriented in the machine direction (MD) in a draw ratio of at least 1:3, preferably in a draw ratio of 1:3 to 1:10.

In a preferred embodiment (i) the invention provides a laminated multilayer film (abbreviated herein as laminated film) which comprises

(a) at least said outer layer (B) and said inner layer (C) as defined above in the form of a multilayer film laminate, and (b) a substrate,

wherein said inner layer (C) of said film laminate (a) is in contact with the surface of said substrate (b), and wherein said multilayer laminated film is uniaxially stretched in the MD as defined above.

In embodiment (i), at least the two layers (B) (i) and (C) (ii) of the film laminate (a) are preferably in extruded form, more preferably in coextruded form, i.e. as a coextrudate. Thus preferably the laminated film of the invention comprises a coextruded film laminate (a) on the surface of said substrate (b).

Moreover, in this embodiment both said film laminate (a) and said substrate (b) are uniaxially oriented in MD.

Herein the term “layer (C) (ii) comprises at least one polymer component which has a Tm≦100° C.” means herein that the layer (C) as defined above or below in any of the embodiments may comprise one or more polymer components, whereby at least one polymer component starts to melt at said temperature at least 100° C. or below.

The term “multilayer film is in the form of a stretched film which is uniaxially oriented in the machine direction (MD)” means that the film is oriented, i.e. stretched, uniaxially to at least 3 times its original length in the machine direction during its manufacture, before the use thereof in the desired end application, preferably as a packaging material (e.g. before the preparation of the packaging article, such as a bag or sack). Also preferably, the film is oriented only uniaxially in MD. Thus the film of the invention preferably excludes films oriented biaxially in MD and in TD, i.e. transverse direction. Preferred films of the invention are also not cross laminted.

The terms “extruded”, or respectively, “coextruded” and “coextrudate”, as used herein mean well known film (co)extrusion, preferably blown film (co)extrusion, processes and the product thereof.

The term “laminated multilayer film” or “laminated film” is well known in the art and means that said prior formed film laminate (a), preferably a multilayer coextruded film laminate, is contacted with a surface of a substrate (b) and adhered thereon by any lamination techniques in a manner well known in the art, for example, but not limited to, by heat lamination at a temperature above the melting temperature of one or more of the polymer components of layer (C) (ii), whereby at least partly molten layer (C) (ii) adheres on the substrate (b).

The film laminate (a) can be laminated on the substrate (b) prior to, or preferably, during the stretching to provide orientation in MD. In the above embodiment, thus both the laminate (a) and the substrate (b) are stretched, i.e. oriented, while in contact with each other.

In embodiment (i) said substrate (b) can be any substrate conventionally used in the film lamination field, provided that the substrate (b) is stretchable in machine direction. Preferably, the substrate (b) is a polymer based film structure, more preferably a uni- or multilayer film, wherein the film layer(s) comprise one or more polymer components and optionally additives that are conventionally used in the field of polymeric films. More preferably, said substrate (b) comprises at least: (iii) an inner layer (C) comprising at least one polymer component which has a Tm≦100° C., and, optionally,
(iv) an outer layer (B).

Preferably said substrate (b) comprises at least the layers (C) (iii) and (B) (iv), whereby the layer (C) (iii) is in contact with layer (C) (ii) of the film laminate. More preferably the layers (C) (iii) and (B) (iv) of the substrate are also in the form of an extruded, preferably coextruded, multilayer film structure, i.e. in a form of a coextrudate.

In one preferable embodiment (i) of the invention, the coextruded film laminate (a) of at least layers (B) (i) and (C) (ii) is laminated on the coextruded film substrate (b) of at least layers (C) (iii) and (B) (iv).

A preferred film of the invention therefore comprises:
(i) a layer (B) and
(ii) a layer (C), in the form of a coextruded multilayer film as said film laminate (a), and,
(iii) a layer (C) and
(iv) a layer (B), in the form of a coextruded multilayer film as said substrate (b), wherein said coextruded laminate (a) and coextruded substrate (b) are laminated together.

Accordingly, in embodiment (i) said layer (C) (iii) and said layer (C) (ii) are adjacent. These layers may comprise the same or different polymer composition and said optional layer (B) (iv) and said layer (B) (i) may comprise the same or different polymer composition. Preferably, at least the polymer composition of layers (C) (ii) and (C) (iii) are the same (e.g. layers (C) (ii) and (C) (iii) are identical). In such a case, when forming the laminated film structure by heat lamination, the at least partly molten layers (C) (ii) and (C) (iii) are fused together, whereby the laminated layers (C) (ii) and (C) (iii) form together the innermost, i.e. core, layer of the laminated and uniaxially (MD) stretched film of the invention. When this is the case the layers may be non-distinguishable in the final film. Such films may therefore be considered to comprise of three layers.

Particularly preferably both the film laminate (a) and the substrate (b) are multilayer films with the same layer structure and polymer composition, more preferably, both have the same coextruded multilayer film structure and the polymer composition.

The invention is also directed to a film laminate (a) as defined above and below for producing a laminated multilayer film that is uniaxially oriented in MD.

Viewed from yet another aspect, the invention provides use of a film as described above or below in packaging e.g. for preparing a packaging article, e.g. a sack or bag.

Viewed from a still further aspect, the invention provides an article, preferably a packaging article, such as sack or bag comprising a film as herein before or hereinafter described.

In one preferable film embodiment (ii) of the invention, said film as defined above contains layers in the following order:
(i) layer (B),
(ii) layer (C),
(iii) layer (C) and
(iv) layer (B).

This order is referred to herein as BCCB.

The film of this embodiment (ii) can be non-laminated or, preferably, laminated.

Moreover, in embodiment (ii) layers (B) (i) and (B) (iv) and/or layers (C) (ii) and (C) (iii) may comprise the same or different polymer composition(s), preferably at least layers (C) (ii) and (C) (iii) comprise the same polymer composition as defined above for layer (C). More preferably also layers (B) (i) and (iv) comprise the same polymer composition as defined above for layer (B).

In the preferable laminated embodiment (ii) layers (B) (i) and (C) (ii) form said film laminate (a) and layers (C) (iii) and (B) (iv) form said substrate (b). Furthermore, a laminated film of embodiment (ii) preferably consists of said film laminate (a), which comprises at least said outer layer (B) (i) and said inner layer (C) (ii), on a surface of a substrate (b), which comprises at least the layer (C) (iii) and layer (B) (iv). More preferably, said film laminate (a) is a coextrudate comprising, preferably consisting of, layers (B) (i) and (C) (ii). Also preferably, the substrate (b) is a coextrudate comprising, preferably consisting of, (C) (iii) and (B) (iv). In such films comprising two (B) layers and two (C) layers, the (C) layers preferably form the core layer, i.e. the innermost layers.

The film BCCB, can be used both for lightweight and heavyweight packaging applications. It is particularly suitable for less demanding “lightweight” applications, such as bags and sacks for loadings up to 5 kg, and provides packaging articles with optimum mechanical properties with decreased film thicknesses.

The films of the invention may also comprise other layers depending on the desired end application, e.g. if used for heavy loads and/or other mechanically demanding applications.

Thus embodiment (ii) includes films of the present invention which comprise at least one further layer (A). Such films preferably comprise (e.g. consist of) layers in the following order:
(i) a first outer layer (A),
(ii) a second outer layer (B) and
(iii) an inner layer (C).

This order is referred to herein as ABC. The outer layer (A) (i) is preferably different from the layers (B) and (C) and preferably comprises a linear low density polyethylene (LLDPE).

In another preferable embodiment (iii) of the invention the films of the invention comprise at least five or six layers, preferably in the following order:
(i) a first outer layer (A),
(ii) a second outer layer (B),
(iii) a first inner layer (C),
(iv) a second inner layer (C),
(v) a third outer layer (B) and
(vi) a fourth outer layer (A)

This order is referred to herein as ABCCBA. The film of embodiment (iii) may be non-laminated or, preferably, a laminated film as defined above. Such laminated film embodiment (iii) comprises, preferably consists of, said film laminate (a) comprising, preferably consisting of, layer (A) (i), layer (B) (ii) and layer (C) (iii); and said substrate (b) comprising, preferably consisting of layer (C) (iv), layer (B) (v) and layer (A) (vi). Layers (C) (iii) and (C) (iv) form the innermost layers of the film of embodiment (iii).

Furthermore, also in said embodiment (iii) layers (A) (i) and (A) (vi) may comprise the same or different, preferably the same, polymer composition; layers (B) (ii) and (B) (v) may comprise the same or different, preferably the same, polymer composition; and, respectively, layers (C) (iii) and (C) (iv) may comprise the same or different, preferably the same polymer composition. It is preferred that at least the layers (C) (iii) and (C) (iv) have the same polymer composition, whereby they form together the core/innermost layers of the laminated multilayer film. When this is the case the layers may be non-distinguishable in the final film. Such films may therefore be considered to comprise of five layers.

Embodiments (iii) includes also films, wherein layer A (i) and layer B (ii) have the same polymer composition and/or layer B (v) and layer (A) (vi) have the same polymer composition (BBCCBB).

More preferably in embodiment (iii) said film laminate (a) is a coextruded multilayer film laminate as defined above and said substrate (b) is a coextruded multilayer film substrate as defined above.

Embodiment (iii) is suitable both for light and heavy weight packaging applications. ABCCBA films are particularly suitable as packaging material for heavy duty applications, e.g. for loadings up to 25 kg or even up to 50 kg, such as for heavy duty shipping sacks (HDSS) or form fill and seal (FFS) sacks. The film embodiment (iii) provides heavy duty packaging material which meets the demanding mechanical requirements with decreased film thicknesses.

### Film Preparation Process

Viewed from a further aspect, the invention is directed to a process for the preparation of a multilayer film as hereinbefore defined comprising forming a film by extruding, preferably coextruding, at least

a composition (b) comprising a multimodal LLDPE as the outer layer (B), and

a composition (c) comprising at least a polymer component which has a Tm≦100° C. as the inner layer (C),

and stretching said film in the machine direction in a draw ratio of at least 1:3, preferably in a draw ratio of 1:3 to 1:10.

A preferred embodiment of the process of the invention provides a process for the preparation of a laminated multilayer film of the invention comprising
extruding at least a composition (b) as defined above and a composition (c) as defined above to form a film laminate (a) of the invention,
contacting said laminate with a substrate (b) of the invention as defined above,
laminating said film laminate (a) and substrate (b), and
stretching the obtained laminated multilayer film in the MD as defined above.

The lamination of film laminate (a) and substrate (b) can occur prior to or during the stretching step. Lamination and stretching processes are known in the film field. Lamination is preferably effected by heat. Alternatively, lamination using an adhesive can also be used.

In the preparation process of laminated film of the invention, the film laminate (a) is preferably formed by coextrusion. More preferably the substrate (b) is also prepared by extruding, preferably coextruding, at least a composition (b) as defined above and a composition (c) to form an extrudate, preferably coextrudate, substrate (b). The obtained coextrudates of film laminate (a) and substrate (b) are then laminated together and stretched uniaxially in MD as defined above and below.

A preferred preparation method of the laminated ABCCBA film of the invention preferably comprises
coextruding a film of ABC to form a coextrudate film laminate (a), ABC, as defined above,
coextruding a film ABC to form a coextrudate substrate (b), CBA, as defined above,
contacting said coextrudate film laminate ABC (a) on the surface of said coextrudate substrate CBA (b), in that layer order,
laminating said ABCCBA structure together, preferably by heat laminating at a temperature of 100° C. or more, and
stretching the laminated film uniaxially in machine direction (MD) in a draw ratio of at least 1:3.

Preferably, the lamination step is effected during the stretching/orientation step. Naturally, the described process applies similarly to laminated film embodiments (i) and (ii) BCCB.

Films obtainable by the processes of the invention form a further aspect of the invention.

The laminated film embodiments of the invention provide a feasible way to utilize (co)extrusion techniques for producing heavy duty packaging material which require before the stretching step a film material with original/starting film thickness higher than thicknesses conventionally producible in commercial (co)extrusion, e.g. blown coextrusion, film lines.

The layer structures as defined herein above and below are layers directly contacting the adjacent layer(s), in the given order and preferably without any adhesive layer or surface treatment applied.

Preferably in embodiment (i), (ii) and (iii), the film is a laminated film oriented in a machine direction (MD) in a draw ratio of 1:3 to 1:10.

A further advantage of the film of the invention is the good processability of the polymer materials. The LLDPE combination of the invention enables for example high production rates and decreased film thicknesses.

Film Layers

The below given definitions of polymer compositions, structures and preparation processes of “layer (B)”, “layer (C)” and “layer (A)” apply herein generally to layers identified with (B), (C) and (A) in any film structure of the invention, e.g. in laminate (a) and substrate (b) of a laminated film.

Moreover, the definitions given for suitable polymer compositions, e.g. for LLDPE, znLLDPE, mLLDPE, LDPE and ethylene acrylate copolymer, in relation to an individual layer (B), (C) or (A) naturally apply and are generalizable to said polymer compositions when present in another layer(s), unless otherwise stated.

The term “multimodal” used for any polymer composition of the invention, e.g. for linear low density polyethylene composition, referred below as LLDPE, means, if otherwise not specified, multimodalty with respect to molecular weight distribution and includes also bimodal polymer.

Usually, a polyethylene, e.g. LLDPE composition, comprising at least two polyethylene fractions, which have been produced under different polymerization conditions resulting in different (weight average) molecular weights and molecular weight distributions for the fractions, is referred to as “multimodal”. The prefix “multi” relates to the number of different polymer fractions present in the polymer. Thus, for example, a polymer consisting of two fractions only is called “bimodal”. The form of the molecular weight distribution curve, i.e. the appearance of the graph of the polymer weight fraction as a function of its molecular weight, of a multimodal polymer, e.g. LLDPE, will show two or more maxima or at least be distinctly broadened in comparison with the curves for the individual fractions. For example, if a polymer is produced in a sequential multistage process, utilizing reactors coupled in series and using different conditions in each reactor, the polymer fractions produced in the different reactors will each have their own molecular weight distribution and weight average molecular weight. When the molecular weight distribution curve of such a polymer is recorded, the individual curves from these fractions are superimposed into the molecular weight distribution curve for the total resulting polymer product, usually yielding a curve with two or more distinct maxima.

In any multimodal polymer, e.g. LLDPE, there is by definition a lower molecular weight component (LMW) and a higher molecular weight component (HMW). The LMW component has a lower molecular weight than the higher molecular weight component. Preferably, in a multimodal polymer, e.g. LLDPE, of use in this invention at least one of the LMW and HMW components is a copolymer of ethylene. Further preferably, at least the HMW component is an ethylene copolymer. Further preferably, also the lower molecular weight (LMW) component may be an ethylene copolymer. Alternatively, if one of the components is a homopolymer, then the LMW component is preferably the homopolymer.

The term “ethylene copolymer” is again used in this context to encompass polymers comprising repeat units deriving from ethylene and at least one other C₃₋₁₂ alpha olefin monomer. Preferred copolymers are binary and comprise a single comonomer or are terpolymers and comprise two or three comonomers. In any copolymeric HMW component, at least 0.25 mol-%, preferably at least 0.5 mol-%, e.g. at least 1 -mol %, such as up to 10 mol-% of repeat units derive from the comonomer. Ethylene preferably forms the majority of the HMW component.

The term “consisting of” used below in relation to film layer materials is meant to exclude only the presence of other polyolefin components, preferably other polymers. Thus said term includes the presence of additives, e.g. conventional film additives, i.e. each layer independently may contain conventional film additives such as antioxidants, UV stabilizers, colour masterbatches, acid scavengers, nucleating agents, anti-blocking agents, slip agents etc as well as polymer processing agent (PPA).

The general properties of polymer (or film) as given below were determined according to determination methods and using the samples as described below under “Determination methods”

### Layer (B)

Layer (B) comprises a multimodal linear low density polyethylene composition, LLDPE, e.g. bimodal LLDPE.

Still more preferably layer (B) comprises a multimodal LLDPE produced by Ziegler Natta catalyst. Herein such polymers are referred to as znLLDPEs. As already mentioned above, layer (B) of the film laminate (a) and layer (B) of the substrate (b) may comprise the same or different LLDPE composition.

The preferred LLDPE composition is defined below further with preferable properties. The given preferable property ranges are applicable to LLDPE compositions in general and apply herein particularly to a multimodal and unimodal LLDPE, particularly to a multimodal znLLDPE and to a uni- or multimodal mLLDPE, unless otherwise stated below.

The LLDPE in layer (B) of the invention may have a density of no more than 940 kg/m³, e.g. 905-940 kg/m³. For multimodal znLLDPE in particular, the density is preferably more than 915 kg/m³. In certain end applications multimodal znLLDPE has preferably density of 915 to 935 kg/m³.

The melt flow rate, MFR₂, of the LLDPE is preferably in the range 0.01 to g/10 min, e.g. 0.05 to 10 g/10 min, preferably 0.1 to 6.0 g/10 min. For multimodal znLLDPE's in particular, MFR₂ is preferably in the range of 0.1 to 5 g/10 min.

The MFR₂₁ of the LLDPE may be in the range 5 to 500, preferably 10 to 200 g/10 min. The Mw of the LLDPE, preferably of znLLDPE, may be in the range 100,000 to 300,000, preferably 150,000 to 270,000. The Mw/Mn of the LLDPE may be in the range 10 to 30, preferably the Mw/Mn of a multimodal znLLDPE is 10 to 25.

A LLDPE composition, preferably a multimodal znLLDPE, may be formed from ethylene along with at least one C₃₋₁₂ alpha-olefin comonomer, e.g. 1-butene, 1-hexene or 1-octene. Preferably, the LLDPE, preferably a multimodal znLLDPE, is a binary copolymer, i.e. the polymer contains ethylene and one comonomer, or a terpolymer, i.e. the polymer contains ethylene and two or three comonomers.

Preferably, the LLDPE, preferably a multimodal znLLDPE, comprises an ethylene hexene copolymer, ethylene octene copolymer or ethylene butene copolymer. The amount of comonomer present in the LLDPE, preferably in a multimodal znLLDPE, is preferably 0.5 to 12 mol %, e.g. 2 to 10% mole relative to ethylene, especially 4 to 8% mole. Alternatively, comonomer contents present in the LLDPE, preferably multimodal znLLDPE, may be 1.5 to 10 wt %, especially 2 to 8 wt % relative to ethylene.

As stated above a multimodal LLDPE comprises at least a LMW component and a HMW component.

The LMW component of LLDPE preferably has a MFR₂ of at least 50, preferably 50 to 3000 g/10 min, more preferably at least 100 g/10 min. In case of znLLDPE the preferred range of MFR₂ of the LMW component is e.g. 110 to 500 g/10 min. The molecular weight of the low molecular weight component should preferably range from 20,000 to 50,000, e.g. 25,000 to 40,000.

The density of the lower molecular weight component may range from 930 to 980 kg/m³, e.g. 940 to 970 kg/m³ more preferably 945 to 955 kg/m³ in the case of copolymer and 940 to 975 kg/m³, especially 960 to 972 kg/m³ in the case of homopolymer.

The lower molecular weight component preferably forms 30 to 70 wt %, e.g. 40 to 60% by weight of the multimodal LLDPE with the higher molecular weight component forming 70 to 30 wt %, e.g. 40 to 60% by weight.

The higher molecular weight component has a lower MFR₂ and a lower density than the lower molecular weight component.

The higher molecular weight component has preferably an MFR₂ of less than 1 g/10 min, preferably less than 0.5 g/10 min, especially less than 0.2 g/10 min, and a density of less than 915 kg/m³, e.g. less than 910 kg/m³, preferably less than 905 kg/m³. The Mw of the higher molecular weight component may range from 100,000 to 1,000,000, preferably 250,000 to 500,000.

Alternatively, the multimodal LLDPE may comprise other polymer components, e.g. up to 10% by weight of a well known polyethylene prepolymer (obtainable from a prepolymerization step as well known in the art). In case of such prepolymer, the prepolymer component is comprised in one of LMW and HMW components, preferably LMW component, as defined above.

Layer (B) preferably comprises at least 30 wt % of multimodal LLDPE polymer, preferably at least 40%wt, more preferably at least 60%wt, e.g. at least 80%wt LLDPE. The multimodal LLDPE used in layer (B) is preferably a multimodal znLLDPE as defined above.

Layer (B) may comprise other polymer components, such as another LLDPE having the density 940 kg/m³ or less, a non LLDPE polymer component(s) such as high density polyethylene (HDPE), medium density polyethylene (MDPE), both produced in a low pressure polymerization, or LDPE produced in a high pressure polymerization process, such as LDPE homopolymer or LDPE copolymer, e.g. an ethylene acrylate copolymer as described in detail below. If present, such polymers preferably do not contribute more than 60% wt of layer (B), preferably 40% wt or less. The layer (B) is preferably free of other polyolefins, such as LDPE, more preferably free of LDPE homopolymer.

In a preferred embodiment of the film of the invention, layer (B) consists of LLDPE polymer(s). Layer (B) comprises preferably at least multimodal znLLDPE and optionally another znLLDPE and/or mLLDPE. Suitable mLLDPEs are described in relation to layer (A). More preferably, layer (B) consists of multimodal znLLDPE.

### Layer (C)

Layer (C) of the invention preferably comprises at least one ethylene copolymer component having a melting point (Tm) of 100° C. or less, e.g. a melting point of 80 to 95° C. As already mentioned above, layer (C) of the film laminate (a) and layer (C) of the substrate (b) may comprise the same or different ethylene copolymer having a melting point (Tm) of 100° C. or less.

Such polymers include copolymers of ethylene and at least one comonomer selected from vinyl acetate, an acrylate and a C₃₋₁₂ alpha-olefin comonomer, e.g. 1-butene, 1-hexene or 1-octene, e.g. LLDPE composition.

In preferred films of the invention, layer (C) comprises at least one ethylene acrylate copolymer. Such a polymer is formed from an ethylene monomer and an acrylate monomer (and other further comonomers if desired). Preferably, layer (C) comprises an ethylene alkyl acrylate polymer (e.g. an ethylene C₁₋₁₀ alkyl acrylate polymer). Preferred ethylene alkyl acrylate polymers are ethylene methyl acrylate (EMA), ethylene ethyl acrylate and ethylene butyl acrylate, especially EMA. The acrylate content of the ethylene acrylate copolymer may be in the range 1 to 40 wt %, preferably 2 to 30 wt %, more preferably 3 to 28%, especially 5 to 25 wt %. The ethylene acrylate copolymers are very well known and commercially available (e.g. from DuPont) or produced according to or analogously to the polymerization methods descried in the literature for the preparation of ethylene acrylate copolymers, preferably in a high pressure polymerization using organic peroxides in a manner well known in the art.

The ethylene acrylate copolymer preferably forms at least 50% wt of layer (C), preferably at least 70% wt, more preferably at least 80% wt, especially at least 90% wt of layer (C). Layer (C) may comprise other polymer components and if present, such polymers should not contribute more than 30% wt of layer (C), preferably 20% wt or less of layer (C).

In a highly preferred embodiment, layer (C) consists of ethylene acrylate copolymer(s). Most preferably layer (C) consists of EMA.

The density of the ethylene acrylate copolymer may be in the range 905-960 kg/m³, preferably in the range of from 920 to 950 kg/m³, such as 930 to 945 kg/m³.

The MFR₂ of ethylene acrylate copolymers of use in the (C) layer should preferably be in the range 0.01 to 20 g/10 min, e.g. 0.05 to 10, preferably 0.1 to 5.0, e.g. 0.2 to 4.0 g/10 min.

The Vicat softening temperatures of the ethylene acrylate copolymer may be in the range 30 to 80° C. The melting point (Tm) of the ethylene acrylate copolymer may be in the range 80 to 100° C.

### Layer (A)

When present in the films of the invention, layer (A) preferably comprises at least one LLDPE. Still more preferably, layer (A) comprises a znLLDPE and/or a linear low density polyethylene polymer produced using a single site catalyst, e.g. metallocene. Herein the LLDPE produced by single site catalyst, preferably metallocene, is called mLLDPE.

As used herein, the mLLDPE polymer is an ethylene copolymer having a density of 940 kg/m³ or less. Preferred mLLDPE's may have a density of 905-940 kg/m³, more preferably 910 to 937 kg/m³, e.g. 935 kg/m³ or below. In one preferable embodiment even densities of 925 kg/m³ or below are highly feasible.

The mLLDPE is formed from ethylene along with at least one C₃₋₂₀ alpha-olefin comonomer, preferably C₃₋₁₂ alpha-olefin comonomer, e.g. 1-butene, 1-hexene or 1-octene. Preferably, the mLLDPE is a binary copolymer, i.e. the polymer contains ethylene and one comonomer, or a terpolymer, i.e. the polymer contains ethylene and two or three, preferably two, comonomers. Preferably, the mLLDPE comprises an ethylene hexene copolymer, ethylene octene copolymer, ethylene butene copolymer or a terpolymer of ethylene with 1-butene and 1-hexene comonomers. The amount of comonomer present in the mLLDPE is preferably 0.5 to 12 mol %, e.g. 2 to 10% mole, especially 4 to 8% mole. Alternatively viewed comonomer contents present in the mLLDPE may be 1.5 to 10 wt %, especially 2 to 8 wt %.

The MFR₂ of mLLDPE's of use in a layer (A) is preferably in the 0.01 or more, preferably 0.1 to 20 g/10 min, e.g. 0.2 to 10, preferably 0.5 to 6.0, e.g. 0.7 to 4.0 g/10 min. Depending on the end use also as low MFR₂ as 2.5 g/10 min or below may be preferred.

The mLLDPE has preferably a weight average molecular weight (Mw) of 100,000-250,000, e.g. 110,000-160,000.

The mLLDPE may be unimodal or multimodal, both are preferable. By unimodal is meant that the molecular weight profile of the polymer comprises a single peak and is produced by one reactor and one catalyst.

The unimodal mLLDPE polymers preferably posses a narrow molecular weight distribution. The Mw/Mn value is preferably 2 to 10, e.g. 2.2 to 4.

Multimodal mLLDPE comprises at least a LMW component and a HMW component and properties as defined above generally for LLDPE and multimodal znLLDPE in relation to layer (B) above. For mLLDPE the preferred ranges of MFR₂ of the LMW component can be both e.g. 50 to 500 g/10 min and 100 to 400 g/10 min.

Both the LMW and HMW components of multimodal mLLDPE are preferably copolymers of ethylene as defined above. In one preferred embodiment the mLLDPE, preferably the multimodal mLLDPE, is a terpolymer, preferably a terpolymer of 1-butene and 1-hexene.

The molecular weight distribution, Mw/Mn, of a multimodal mLLDPE may be e.g. below 30, preferably between 3-10.

Preferred znLLDPE present in layer (A) is as described above in relation to layer (B).

Layer (A) may comprise other polymers as well. Typically, layer (A) comprises at least 50% wt, preferably at least 80% wt, of LLDPE polymer(s), and more preferably consists of LLDPE polymer(s). The layer (A) is preferably free of other polyolefins, such as LDPE, more preferably free of LDPE homopolymer.

In one embodiment layer (A) comprises, preferably consists of, LLDPE which is a mixture of znLLDPE and mLLDPE, wherein mLLDPE is preferably a unimodal or multimodal mLLDPE. The znLLDPE in said mixture is preferably a multimodal znLLDPE. In said embodiment layer (A) preferably comprises up to 60 % wt mLLDPE, preferably 10-50% wt or less mLLDPE, more preferably 15-50% wt mLLDPE, and at least 40% wt znLLDPE, preferably 50-90% wt znLLDPE, more preferably 50-85 wt % znLLDPE.

In another embodiment layer (A) comprises, preferably consists of, LLDPE which is znLLDPE, preferably multimodal znLLDPE.

### Preparation of Polymer

The polymer compositions, e.g. LLDPE, LDPE, ethylene acrylate copolymers etc., suitable as layer materials of the films of the invention can be any conventional, e.g. commercially available, polymer compositions. Alternatively, suitable polymer compositions can be produced in a known manner according to or analogously to conventional polymerization processes described in the literature of polymer chemistry.

Unimodal polyethylene, e.g. LLDPE, is preferably prepared using a single stage polymerization, e.g. slurry or gas phase polymerization, preferably a slurry polymerization in slurry tank or, more preferably, in loop reactor in a manner well known in the art. As an example, a unimodal LLDPE can be produced e.g. in a single stage loop polymerization process according to the principles given below for the polymerization of low molecular weight fraction in a loop reactor of a multistage process, naturally with the exception that the process conditions (e.g. hydrogen and comonomer feed) are adjusted to provide the properties of the final unimodal polymer.

Multimodal (e.g. bimodal) polymers can be made by mechanical blending two or more, separately prepared polymer components or, preferably, by in-situ blending in a multistage polymerization process during the preparation process of the polymer components. Both mechanical and in-situ blending is well known in the field.

Accordingly, preferred multimodal polymers, e.g. LLDPE polymers, are prepared by in-situ blending in a multistage, i.e. two or more stage, polymerization or by the use of two or more different polymerization catalysts, including multi- or dual site catalysts, in a one stage polymerization.

Preferably the multimodal polymer, e.g. LLDPE, is produced in at least two-stage polymerization using the same catalyst, e.g. a single site or Ziegler-Natta catalyst. Thus, for example two slurry reactors or two gas phase reactors, or any combinations thereof, in any order can be employed. Preferably however, the multimodal polymer, e.g. LLDPE, is made using a slurry polymerization in a loop reactor followed by a gas phase polymerization in a gas phase reactor.

A loop reactor—gas phase reactor system is marketed by Borealis as a BORSTAR reactor system. Any multimodal polymer, e.g. LLDPE, present in layers is thus preferably formed in a two stage process comprising a first slurry loop polymerization followed by gas phase polymerization.

The conditions used in such a process are well known. For slurry reactors, the reaction temperature will generally be in the range 60 to 110° C. (e.g. 85-110° C.), the reactor pressure will generally be in the range 5 to 80 bar (e.g. 50-65 bar), and the residence time will generally be in the range 0.3 to 5 hours (e.g. 0.5 to 2 hours). The diluent used will generally be an aliphatic hydrocarbon having a boiling point in the range −70 to +100° C. In such reactors, polymerization may if desired be effected under supercritical conditions. Slurry polymerization may also be carried out in bulk where the reaction medium is formed from the monomer being polymerized.

For gas phase reactors, the reaction temperature used will generally be in the range 60 to 115° C. (e.g. 70 to 110° C.), the reactor pressure will generally be in the range 10 to 25 bar, and the residence time will generally be 1 to 8 hours. The gas used will commonly be a non-reactive gas such as nitrogen or low boiling point hydrocarbons such as propane together with monomer (e.g. ethylene).

Preferably, the lower molecular weight polymer fraction is produced in a continuously operating loop reactor where ethylene is polymerized in the presence of a polymerization catalyst as stated above and a chain transfer agent such as hydrogen. The diluent is typically an inert aliphatic hydrocarbon, preferably isobutane or propane.

The higher molecular weight component can then be formed in a gas phase reactor using the same catalyst.

Where the higher molecular weight component is made second in a multistage polymerization it is not possible to measure its properties directly. However, the skilled man is able to determine the density, MFR₂ etc of the higher molecular weight component using Kim McAuley's equations. Thus, both density and MFR₂ can be found using K. K. McAuley and J. F. McGregor: On-line Inference of Polymer Properties in an Industrial Polyethylene Reactor, AIChE Journal, June 1991, Vol. 37, No, 6, pages 825-835.

The density is calculated from McAuley's equation 37, where final density and density after the first reactor is known.

MFR₂ is calculated from McAuley's equation 25, where final MFR₂ and MFR₂ after the first reactor is calculated. The use of these equations to calculate polymer properties in multimodal polymers is common place.

The multimodal polymer, e.g. LLDPE, may be made using any conventional catalyst, such as a chromium, single site catalysts, including metallocenes and non-metallocenes as well known in the field, or Ziegler-Natta catalysts as is also known in the art. The preferred are any conventional Ziegler Natta and single site catalysts and the choice of an individual catalyst used to make znLLDPE or mLLDPE, respectively, is not critical.

In case of mLLDPE, metallocene catalysis is preferably used. The preparation of the metallocene catalyst can be carried out according or analogously to the methods known from the literature and is within skills of a person skilled in the field. Thus for the preparation see e.g. EP-A-129 368, WO-A-9856831, WO-A-0034341, EP-A-260 130, WO-A-9728170, WO-A-9846616, WO-A-9849208, WO-A-9912981, WO-A-9919335, WO-A-9856831, WO-A-00/34341, EP-A-423 101 and EP-A-537 130. WO2005/002744 describes a preferable catalyst and process for preparing the mLLDPE component.

In case of znLLDPE the polyethylene polymer composition is manufactured using Ziegler-Natta catalysis. Preferred Ziegler-Natta catalysts comprise a transition metal component and an activator. The transition metal component comprises a metal of Group 4 or 5 of the Periodic System (IUPAC) as an active metal. In addition, it may contain other metals or elements, like elements of Groups 2, 13 and 17. Preferably, the transition metal component is a solid. More preferably, it has been supported on a support material, such as inorganic oxide carrier or magnesium halide. Examples of such catalysts are given, among others in WO 95/35323, WO 01/55230, WO 2004/000933, EP 810235 and WO 99/51646.

In a very preferable embodiment of the invention the polyethylene composition is produced using a ZN catalysts disclosed in WO 2004/000933 or EP 688794.

A LDPE, e.g. LDPE homopolymer or LDPE copolymer, may be prepared according to any conventional high pressure polymerizations (HP) process in a tubular or autoclave reactor using a free radical formation. LDPE prepared by high pressure polymerization in a tubular reactor is preferred. Such HP processes are very well known in the field of polymer chemistry and described in the literature. Further details about high pressure radical polymerization are, for example, given in WO 93/08222.

MDPE and HDPE can be prepared using the procedure hereinbefore described for LLDPE, but adjusting the process conditions in a manner known to a skilled person to provide the density of MDPE and HDPE. HDPE that may be present in the film of the invention has a density of 950 to 980 kg/m³. MDPE that may be present in the film of the invention has a density of 941-949 kg/m³.

Conventional cocatalysts, supports/carriers, electron donors etc can be used.

The films of the invention may incorporate one or more barrier layers as is known in the art. For certain applications for example, it may be necessary to incorporate a barrier layer, i.e. a layer which is impermeable to oxygen, into the film structure. This can be achieved using conventional lamination techniques or by coextrusion.

### Film Preparation

For film formation using polymer mixtures the different polymer components (e.g. within layers (A), (B) and (C)) are typically intimately mixed prior to extrusion and blowing of the film as well known in the art. It is especially preferred to thoroughly blend the components, for example, using a twin screw extruder, preferably a counter-rotating extruder prior to extrusion and film blowing.

The preparation process of a uniaxially oriented in MD multilayer film of the invention comprises at least the steps of forming a layered film structure and stretching the obtained multilayer film in the machine direction in a draw ratio of at least 1:3.

As to the first step of the preparation process, the layered structure of the film of the invention may be prepared by any conventional film formation process including extrusion procedures, such as cast film or blown film extrusion, lamination processes or any combination thereof. BC and ABC films are preferably produced by extrusion.

Particularly preferably at least the multilayer film of layers (B), (C) and optionally (A) is formed by blown film extrusion, more preferably by blown film coextrusion processes as described above. Typically the compositions providing layers (B), (C) and optionally (A) will be blown (co)extruded at a temperature in the range 160° C. to 240° C., and cooled by blowing gas (generally air) at a temperature of 10 to 50° C. to provide a frost line height of 1 or 2 to 8 times the diameter of the die. The blow up ratio should generally be in the range 1.2 to 6, preferably 1.5 to 4.

In the case of the non-laminated film embodiments of the invention, i.e. BC or ABC, the formed, preferably coextruded, multilayer film is subjected to a stretching step as described below.

Preferred laminated film embodiments (i) to (iii) of the invention, i.e. (film laminate (a))/(substrate (b)), preferably BCCB or more preferably ABCCBA, additionally involve a lamination step before the stretching step. Thus the multilayer film obtained from the first step is used in the subsequent lamination step as a film laminate (a). Also in laminated films said laminate (a) is preferably produced by coextrusion of BC or ABC films. The obtained laminate (a), preferably coextrudate BC or ABC, is then contacted with a surface of a substrate (b) and the layered structure is laminated. As mentioned above, the substrate (b) is preferably also a coextruded CB or CBA multilayer film, whereby the coextrudates BC/CB and, respectively, ABC/CBA, are laminated together in the given layer orders.

Preferably in laminated embodiments (i), (ii) and (iii), BCCB and ABCCBA, both the film laminate (a), BC or ABC, and the substrate (b) CB or CBA, have the same coextruded multilayer film structure, whereby said laminated film can advantageously be prepared first by coextruding compositions forming the layers (B), (C) and optionally (A) through an annular die, blowing by blown extrusion into a tubular film to form a bubble. The formed bubble is then collapsed e.g. in nip rolls to form said laminate (a) and said substrate (b) which are contacted inside/inside, BC/CB or ABC/CBA, and laminated, preferably heat laminated. Lamination is preferably effected during the subsequent stretching step.

As to the stretching step, after forming the multilayer film, and, for laminated embodiments, after subjecting to a lamination step, the multilayer film is stretched in the machine direction. Stretching may be carried out by any conventional technique using any conventional stretching devices which are well known to those skilled in the art. Preferably, the film is stretched only in the MD. The effect of stretching in only one direction is to uniaxially orient the film. Stretching is preferably carried out at a temperature in the range 70-90° C., e.g. about 80° C. Any conventional stretching rate may be used, e.g. 2 to 40%/second.

In the case of laminated film embodiments it is preferred that the stretching step is effected after the surfaces of laminate (a) and substrate (b) have been put into contact with each other.

The film is stretched at least 3 times, preferably 3 to 10 times, its original length in the machine direction. This is stated herein as a draw ratio of at least 1:3, i.e. “1” represents the original length of the film and “3” denotes that it has been stretched to 3 times that original length. Preferred films of the invention are stretched in a draw ratio of at least 1:4, more preferably between 1:5 and 1:8, e.g. between 1:5 and 1:7. An effect of stretching (or drawing) is that the thickness of the film is similarly reduced. Thus a draw ratio of at least 1:3 preferably also means that the thickness of the film is at least three times less than the original thickness.

Blow extrusion and stretching techniques are well known in the art, e.g. in EP-A-299750.

In the case of non-laminated film embodiments, the final, uniaxially oriented in MD films can be further processed, e.g. laminated on a substrate. Preferably non-laminated films of the invention are used in non-laminated film applications.

The film preparation process steps of the invention are known and may be carried out in one film line in a manner known in the art. In a preferred process for preparation of the laminated film, the film lamination is preferably effected by heat lamination, whereby the lamination step can occur during the stretching step. Still more preferably the lamination step is achieved in the same film preparation line as the stretching step and preferably occurs at the same time as stretching. Such film lines are commercially available.

The films obtained by the processes of the invention can be used for preparing packaging, such as sacks or bags, in a known manner. In a preferred embodiment the film is further processed to tubular films which are either used directly in conventional vertical or horizontal form-fill-seal machines as well known in the art or are made into tubular films by conventional tube making machines and used thereafter in packaging. This may be carried out in-line during film production or off-line by conventional techniques. The tubular film can then be fed to a form, fill and seal (FFS) machine for use in packaging.

The film, preferably ABCCBA film, of the present invention is also ideally suited for the manufacture of heavy duty shipping sacks. Such sacks/bags may be made in different shapes and sizes and may be gusseted in a known manner.

Such bags and sacks are intended to contain materials up to 50 kg in weight (e.g. 5-50 kg in weight) and can be stacked on pallets. Different stacking arrangements are well known in the art.

### Film Properties

In the laminated film of the invention, wherein also the substrate (b) comprises the layers (B), (C) and, if present, (A), these layers may have the same thickness as the corresponding layers (B), (C) and, if present, (A) of the film laminate (a). Preferably layers (B) of said laminate (a) and said substrate (b), layers (C) of said laminate (a) and said substrate (b), and, if present, layers (A) of said laminate (a) and said substrate (b) have the same thickness. More preferably at least layers (C) of said laminate (a) and said substrate (b) have the same polymer composition. Preferably, also layer (B) of said laminate (a) and optional layer (B) of said substrate (b) have the same polymer composition.

Further preferably, the films BCCB and, respectively, ABCCBA, consist of layers BCCB and, respectively, ABCCBA. More preferably, in laminated films, BCCB and ABCCBA, the multilayer film laminate (a), BC or, respectively ABC, and substrate (b), CB or, respectively, CBA are formed from the same BC- or ABC-film material (i.e. same layer structure and layer composition) and laminated by inside/inside lamination.

In a non-laminated film of the invention comprising, preferably consisting of, layers BC, layer (B) preferably forms 30 to 95%, more preferably 50 to 90%, of the total thickness of the multilayer film structure and layer (C) forms about 5 to 70%, more preferably 10 to 50% of the total thickness of the multilayer film structure. If layer (A) is present, then the non-laminated film preferably consists of ABC layers, whereby layer (A) preferably forms 15 to 55%, more preferably 20 to 45%, of the total thickness of the multilayer film structure, layer (B) preferably forms 30 to 70%, more preferably 35 to 60%, of the total thickness of the multilayer film structure and layer (C) forms about 5 to 25%, more preferably 10 to 20%, of the total thickness of the multilayer film structure.

In case of laminated film of the invention comprising, preferably consisting of, BCCB, the layers (B) have equal thicknesses and preferably amount together to 30 to 95%, more preferably 50 to 90%, of the total thickness of the multilayer film structure. Layers (C) have preferably equal thicknesses and amount together to about 5 to 70%, more preferably 10 to 50% of the total thickness of the multilayer film structure.

In ABCCBA laminated films, preferably layers (A) have equal thicknesses and together form 15 to 55%, more preferably 20 to 45%, of the total thickness of the ABCCBA film structure. Similarly, layers (B) preferably have equal thicknesses and together form 30 to 70%, more preferably 35 to 60%, of the total thickness of the ABCCBA film structure. Also layers (C) preferably have equal thicknesses and together form about 5 to 25%, more preferably 10 to 20%, of the total thickness of the ABCCBA film structure.

Accordingly, the thickness distribution for a laminated BCCB film is thus 15-47.5%/5-70%/15-47.5%, wherein the total film thickness is 100% and the amount of core layer is the sum of two layers (C), and for laminated ABCCBA film 7.5-27.5%/15-35%/5-25%/15-35%/7.5-27.5%, wherein the total film thickness is 100% and the amount of core layer is the sum of two layers (C).

Both non-laminated or laminated films apply for light weight and heavy weight/duty applications.

The total thickness of the film of the invention depends on the intended end use. The “final thickness” means the total thickness of the stretched multilayer film. The term “starting” or “original” thickness of a film means the total thickness of the film of the invention prior to stretching step.

Accordingly, in said non-laminated or laminated light weight applications the original thickness before stretching is 400 μm or less, preferably from 40 to 300 μm, more preferably from 50 to 300 μm, such as from 100 to 300 μm, even more preferably from 200 to 280 μm.

For heavy weight/heavy duty applications up to 50 kg, the original thickness of the film, preferably laminated film, before stretching is preferably 800 μm or less, preferably from 200 to 600 μm, more preferably from 300 to 600 μm.

The final films of the present invention after stretching typically have a thickness of 140 μm or less, preferably 20 to 120 μm.

More specifically, films comprising, preferably consisting of, non-laminated or laminated BC, ABC or BCCB structures for use in light weight packaging applications up to e.g. 5 kg preferably have a final thickness of preferably 10 to 100 μm, more preferably 15 to 80 μm, still more preferably 20 to 50 μm, e.g. 25 to 40 μm.

Films comprising, preferably consisting of, non-laminated or preferably laminated BCCB or ABCCBA structures for heavy weight/duty packaging applications up to e.g. 50 kg preferably have a final thickness of 40 to 135 μm, more preferably 50 to 120 μm, still more preferably 55 to 100 μm, e.g. 60 to 90 μm.

As an example of a laminated film of the invention, preferably for heavy weight/heavy duty applications, the film laminate (a) is a ABC coextrudate and the substrate (b) is a coextrudate CBA, preferably laminate (a) and substrate (b) have the same film layer structure and composition, are laminated together in the above layer order, each laminate (a) and substrate (b) having the thickness of 240 μm. Thus after lamination the starting (original) film thickness of the laminated film is 480 μm before stretching and after the stretching in draw ratio of e.g. 1:6, the final, i.e. total, film thickness of the uniaxially in MD oriented laminated film of the invention is 80 μm.

The film of the invention and the sacks and bags produced therefrom exhibit a remarkable combination of mechanical properties. For instance the present films for heavy weight/duty packaging applications provide excellent impact strength, and preferably excellent tear resistance in MD as well as creep resistance in MD whilst having a lesser thickness, i.e. thickness of 140 μm or less, preferably 100 μm or less, e.g. about 80 μm, compared to prior art films.

The general definitions for film properties provided below were determined separately both for film for use in light weight packaging applications with loads e.g. up to 5 kg and film for use in heavy weight/duty packaging applications with loads e.g. up to 50 kg using different film samples.

Film sample used for determining the film properties for use in said heavy weight/duty packaging applications was a uniaxially (MD) stretched ABCCBA film sample with original thickness of 480 μm before stretching, final film thickness of 80 μm after stretching and thickness distribution (%) of 20/22.5/7.5/7.5/22.5/20 of the total film thickness.

Film sample used for determining the film properties for use in said light weight packaging applications was a uniaxially (MD) stretched ABCCBA film sample with original thickness of 330 μm before stretching, final film thickness of 55 μm after stretching and thickness distribution (%) of 15/27.5/7.5/7.5/27.5/15 of the total film thickness. Both film samples were made according to method described below under “Film Sample Preparation”, unless otherwise stated under the description of “Determination methods”.

As mentioned above, the films of the present invention exhibit remarkable impact resistance, i.e. impact strength expressed herein as relative impact strength as determined according to the method described under “Determination methods” below. The relative impact resistance of preferred films for use in light weight applications e.g. up to 5 kg loads, is preferably 2 g/μm or more, e.g. 2-20 g/μm, preferably 3 g/μm or more, when determined with the 55 μm film sample as defined above. The upper limit is not critical and can be e.g. less than 10 g/μm.

In preferred films for use in heavy weight/duty packaging applications up to e.g. 50 kg loads, said relative impact strength is preferably 2 g/μm or more, preferably 3 g/μm or more, more preferably 5 g/μm or more, and in some demanding end applications advantageously even 7 g/μm or more, when determined with the 80 μm film sample as defined above. The upper limit is not limited, but typically less than 20 g/μm.

The film of the invention preferably also has very desirable tear resistance in machine direction (MD) expressed as relative tear resistance as defined under the title “Determination methods” below.

In preferred films for use in light weight packaging applications e.g. up to 5 kg, the relative tear resistance (in Machine Direction) is 40 N/mm or more, preferably 50 N/mm or more when determined with the 55 μm film sample as defined above. The upper limit is not limited, but may be e.g. 200 N/mm, such a 1000 N/mm.

In preferred films for use in heavy weight/duty packaging applications, the film preferably has a relative tear resistance in MD (Machine Direction) of 40 N/mm or more, preferably 60 N/mm or more, when determined with the 80 μm film sample as defined above. In demanding embodiments relative tear resistance in MD of even 80 N/mm or more, or as high as 100 N/mm or more, is preferred, when determined with the 80 μm film sample as defined above. The upper limit again is not limited, but could be e.g. 200 N/mm.

More preferably, especially in heavy weight/duty applications up to 50 kg loads, the film of the invention has also very good creep properties in machine direction, MD, according to creep determination method as defined under the title “Determination methods” below. Accordingly in such applications the creep resistance of preferred films in MD (%) at 23 N load, at temperature of 23° C. is 10% or less, when determined with the 80 μm film sample as defined above. In demanding embodiments preferable creep resistance in MD is even 8% or less. The lower limit is not limited but may be 0.5%.

The creep resistance of the films of the invention provides excellent pallet stability.

Furthermore the film of the invention has very good printability and sealability properties. The films of the invention preferably also possess a wide sealing range.

In some embodiments of the invention, particularly in heavy weight/duty applications, also stiffness of the film is preferred. Accordingly, stiffness of preferred films expressed as Tensile Modulus in the transverse direction, as measured according to the method given under “Determination methods”, may preferably be at least 350 MPa, more preferably at least 400 MPa, still more preferably at least 450 MPa, e.g greater than 500 MPa, when determined with the 80 μm film sample as defined above. The upper limit is not limited but may be 900 MPa.

Due to the preferable mechanical properties of the films their further processing e.g. in printing and packaging machines is excellent.

The films of the invention, especially ABC films, may therefore also be used in flexible packaging. The oriented films may, for example, be printed (e.g. flexoprinted or laminated) onto other substrates and films (e.g. films made from polyethylene, polypropylene, PET or polyacrylic acid) and the resulting films/laminates converted into bags or pouches. Any shape and/or size of bag may be prepared.

The attractive properties of the films of the invention mean they have a wide variety of applications but are of particular interest in the formation of bags and sacks. Such sacks/bags may be made in different shapes and sizes.

The invention will now be described with reference to the following non-limiting examples.

### Examples

### Determination Methods

Unless otherwise stated, the samples used for the measurements to define the above and below properties of the polymers were polymer samples prepared in accordance with the standards specified.

Unless otherwise stated and/or specified in a standard, the film samples used for the measurements to define the above and below properties of the films were prepared as described under the heading “Film Sample Preparation”.

Density of the materials is measured according to ISO 1183:1987 (E), method D, with isopropanol-water as gradient liquid. The cooling rate of the plaques when crystallizing the samples was 15 C/min. Conditioning time was 16 hours.

MFR₂, MFR₅ and MFR₂₁

The melt flow rate (MFR) is determined according to ISO 1133 and is indicated in g/10 min. The MFR is an indication of the melt viscosity of the polymer. The MFR is determined at 190° C. for PE and at 230° C. for PP. The load under which the melt flow rate is determined is usually indicated as a subscript, for instance MFR₂ is measured under 2.16 kg load, MFR₅ is measured under 5 kg load or MFR₂₁ is measured under 21.6 kg load.

Molecular Weights, Molecular Weight Distribution, Mn, Mw, MWD

The weight average molecular weight Mw and the molecular weight distribution (MWD=Mw/Mn wherein Mn is the number average molecular weight and Mw is the weight average molecular weight) is measured by a method based on ISO 16014-4:2003. A Waters 150CV plus instrument, equipped with refractive index detector and online viscosimeter was used with 3×HT6E styragel columns from Waters (styrene-divinylbenzene) and 1,2,4-trichlorobenzene (TCB, stabilized with 250 mg/L 2,6-Di tert butyl-4-methyl-phenol) as solvent at 140° C. and at a constant flow rate of 1 mL/min. 500 μL of sample solution were injected per analysis. The column set was calibrated using universal calibration (according to ISO 16014-2:2003) with 10 narrow MWD polystyrene (PS) standards in the range of 1.05 kg/mol to 11 600 kg/mol. Mark Houwink constants were used for polystyrene and polyethylene (K: 19×10⁻³ dL/g and a: 0.655 for PS, and K: 39×10⁻³ dL/g and a: 0.725 for PE). All samples were prepared by dissolving 0.5-3.5 mg of polymer in 4 mL (at 140° C.) of stabilized TCB (same as mobile phase) and keeping for 2 hours at 140° C. and for another 2 hours at 160° C. with occasional shaking prior sampling in into the GPC instrument.

Tm and Tcr were both measured according to ISO 11357-1 on Perkin Elmer DSC-7 differential scanning calorimetry. Heating curves were taken from −10° C. to 200° C. at 10° C./min. Hold for 10 min at 200° C. Cooling curves were taken from 200° C. to −10° C. per min. Melting and crystallization temperatures were taken as the peaks of endotherms and exotherms. The degree of crystallinity was calculated by comparison with heat of fusion of a perfectly crystalline polyethylene, i.e. 290 J/g.

Comonomer Content (NMR) was determined by using ¹³C-NMR. The ¹³C-NMR spectra were recorded on Bruker 400 MHz spectrometer at 130° C. from samples dissolved in 1,2,4-trichlorobenzene/benzene-d₆ (90/10 w/w). Conversion between % wt and % mol can be carried out by calculation.

Vicat softening temperature (° C.) was determined according to (A) ISO 306.

Impact Strength is determined on Dart-drop (g/50%). Dart-drop is measured using ISO 7765-1, method “A”. A dart with a 38 mm diameter hemispherical head is dropped from a height of 0.66 m onto a film sample clamped over a hole. If the specimen fails, the weight of the dart is reduced and if it does not fail the weight is increased. At least 20 specimens are tested. The weight resulting in failure of 50% of the specimens is calculated and this provides the dart drop impact (DDI) value (g). The relative DDI (g/μm) is then calculated by dividing the DDI by the thickness of the film.

Tear resistance (determined as Elmendorf tear (N)): Applies both for the measurement in machine direction and transverse direction. The tear strength is measured using the ISO 6383/2 method. The force required to propagate tearing across a film sample is measured using a pendulum device. The pendulum swings under gravity through an arc, tearing the specimen from pre-cut slit. The film sample is fixed on one side by the pendulum and on the other side by a stationary clamp. The tear resistance is the force required to tear the specimen. The relative tear resistance (N/mm) is then calculated by dividing the tear resistance by the thickness of the film.

Creep resistance in MD (%), at 23 N load, at temperature of 23C is determined as follows: A film sample cut in machine direction of 25 mm width is fixed in a stationary clamp and a load of 2.3 kg is fixed to the other end of the sample with a clamp so that 100 mm of film sample is left between the two clamps. The testing temperature is 23° C. The free hanging load will make the film slowly yield (elongate). The film length is measured after 24 hours whereby the elongation in percent will be calculated for the sample.

Tensile modulus (secant modulus, 0.05-1.05%) is measured according to ASTM D 882-A on film samples prepared as described under below “Film Sample preparation”. The speed of testing is 5 mm/min. The test temperature is 23° C. Width of the film was 25 mm.

Polymers

mLLDPE 1: A unimodal mLLDPE having a MFR₂ of 1.3 g/10 min and a density of 922 kg/m³.

mLLDPE 2: A multimodal mLLDPE having a MFR₂ of 1.8 g/10 min and a density of 915 kg/m³.

znLLDPE 1: A multimodal znLLDPE having a MFR₂ of 0.2 g/10 min and a density of 923 kg/m³.

znLLDPE 2: A multimodal znLLDPE having a MFR₂ of 0.4 g/10 min and a density of 924 kg/m³.

znLLDPE 3: A multimodal znLLDPE having a MFR₂ of 0.2 g/10 min and a density of 931 kg/m³.

EMA 1 (Elvaoy® 1125 AC, commercially available from DuPont)—A copolymer of ethylene and methyl acrylate containing 25% methyl acrylate, MFR₂ 0.4 g/10 min, density 944 kg/m³, Tm 90° C., Vicat softening temp A50 (10 N)=48° C. (ISO 306). This polymer is commercially available from DuPont™

EMA 2 (Elvaoy® 1224 AC, commercially available from DuPont)—A copolymer of ethylene and methyl acrylate containing 24% methyl acrylate, MFR₂ 2.0 g/10 min, density 944 kg/m³, Tm 91° C., Vicat softening temp A50 (10 N)=48° C. (ISO 306). This polymer is commercially available from DuPont™

Preparation of Polymers

### Example 1

### Polymerization of mLLDPE 2

### Catalyst Preparation Example

Complex: The catalyst complex used in the polymerization example was a silica supported bis(n-butyl cyclopentadienyl)hafnium dibenzyl, (n-BuCp)₂Hf(CH₂Ph)₂, and it was prepared according to “Catalyst Preparation Example 2” of WO2005/002744. The starting complex, bis(n-butyl cyclopentadienyl)hafnium dichloride, was prepared as described in “Catalyst Preparation Example 1” of said WO 2005/002744.

Activated catalyst system: Complex solution of 0.80 ml toluene, 38.2 mg (n-BuCp)₂Hf(CH₂Ph)₂ and 2.80 ml 30 wt % methylalumoxane in toluene (MAO, supplied by Albemarle) was prepared. Precontact time was 60 minutes. The resulting complex solution was added slowly onto 2.0 g activated silica (commercial silica carrier, XPO2485A, having an average particle size 20 μm, supplier: Grace). Contact time was 2 h at 24° C. The catalyst was dried under nitrogen purge for 3 h at 50° C. The obtained catalyst had Al/Hf of 200 mol/mol; Hf 0.40 wt %.

### Polymerization Example

The polymerization was carried out in a continuously operated pilot polymerization process. A prepolymerization step in 50 dm³ loop reactor, at temperature of 60° C. and pressure of 63 bar in the presence of the catalyst, ethylene, 1-butene as a comonomer and propane as diluent in amounts given in table 1 below, preceded the actual polymerization in two stage loop-gas phase reactor system. The reaction product obtained from the prepolymerization step was fed to the actual loop reactor having a volume of 500 dm³ and ethylene, hydrogen, 1-butene as comonomer and propane as diluent were fed in amounts that the ethylene concentration in the liquid phase of the loop reactor was 6.5 mol-%. The other amounts and ratios of the feeds are given in table 1 below. The loop reactor was operated at 85° C. temperature and 60 bar pressure. The formed polymer (LMW component) had a melt index MFR₂ of 110 g/10 min at 26 kg/h.

The slurry was intermittently withdrawn from the reactor by using a settling leg and directed to a flash tank operated at a temperature of about 50° C. and a pressure of about 3 bar.

From the flash tank the powder, containing a small amount of residual hydrocarbons, was transferred into a gas phase reactor operated at 80° C. temperature and 20 bar pressure. Into the gas phase reactor was also introduced additional ethylene nitrogen as inert gas as well as 1-butene and 1-hexene as comonomers in such amounts that the ethylene concentration in the circulating gas was 50 mol-%. The ratio of hydrogen to ethylene, the ratio of comonomers to ethylene and the polymer production rate are given in the below table 1. The production rate was 28 kg/h. The production split between the loop and gas phase reactors was thus 50/50 wt-%.

The polymer collected from the gas phase reactor was stabilized by adding to the powder 1500 ppm Irganox B215. The stabilized polymer was then extruded and pelletized under nitrogen atmosphere with CIM90P extruder, manufactured by Japan Steel Works. The melt temperature was 214° C., throughput 221 kg/h and the specific energy input (SEI) was 260 kWh/kg.

TABLE 1
Polymerisation conditions and the product properties of the obtained
products of example 1

| | | Ex 1 |
|---|---|---|
| Polymerization conditions | Unit | mLLDPE 2 |
| Prepolymerisation | | |
| Temperature | ° C. | 60 |
| Pressure | bar | 63 |
| Catalyst feed | g/h | 33 |
| C2 feed | kg/h | 1.5 |
| C4 feed | g/h | 58 |
| Loop reactor | | |
| C2 concentration | mol-% | 6.5 |
| H2/C2 ratio | mol/kmol | 0.56 |
| C4/C2 ratio | mol/kmol | 107 |
| C6/C2 ratio | mol/kmol | — |
| MFR₂ | g/10 min. | 110 |
| Density | kg/m³ | 938 |
| Prod. rate | kg/h | 26 |
| Gas phase reactor | | |
| C2 concentration | mol-% | 50 |
| H2/C2 ratio | mol/kmol | 0.44 |
| C4/C2 ratio | mol/kmol | 15 |
| C6/C2 ratio | mol/kmol | 19 |
| (1-hexene) | | |
| Prod. rate | kg/h | 28 |
| MFR₂ | g/10 min. | 1.9 |
| Density | kg/m³ | 914 |
| Final product | | |
| Prod. split loop/GPR | wt % | 50/50 |
| Irganox B215 | ppm | 1500 |
| CIM90P | kg/h | 221 |
| throughput | | |
| CIM90P extruder melt temp. | ° C. | 214 |
| CIM90P SEI | kWh/kg | 260 |
| (specific energy input) | | |
| Pellet properties | | |
| Density of the pelletized | kg/m³ | 915 |
| final polymer, | | |
| MFR₂ of the pelletized | g/10 min | 1.8 |
| final polymer | | |

### Example 2

### mLLPE 1

A unimodal ethylene hexene copolymer was produced using a bis(n-butylcyclopentadienyl) hafnium dibenzyl catalyst in a slurry loop reactor at the polymerization conditions given below. For the preparation of the catalyst system, see example 1 above.

### Polymerization Conditions:

| | |
|---|---|
| Pressure: | 42 bar |
| C2 amount in flash gas: | 5 wt % |
| C6/C2 in flash gas: | 130 mol/kmol |
| Temperature: | 86° C. |
| Residence time: | 40 to 60 minutes |

After collecting the polymer it was blended with conventional additives (stabilizer and polymer processing aid) and extruded into pellets in a counterrotating twin-screw extruder JSW CIM90P. The obtained unimodal mLLDPE polymer (polymer 3) had the density of 922 kg/m³ and MFR₂ of 1.3 g/10 min.

### Examples 3-5

### Example 3

### znLLDPE 1

Multimodal znLLDPE polymer was prepared in a pilot scale multistage reactor system containing a loop reactor and a gas phase reactor. A prepolymerization step preceded the actual polymerization step. The prepolymerization stage was carried out in slurry in a 50 dm³ loop reactor at about 80° C. in a pressure of about 65 bar using the polymerization catalyst prepared according to Example 1 of WO 2004/000902 and triethylaluminium as the cocatalyst. The molar ratio of aluminium of the cocatalyst to titanium of the catalyst was about 20. Ethylene was fed in a ratio of (200 g of C2)/(1 g/catalyst). Propane was used as the diluent and hydrogen was fed in amount to adjust the MFR₂ of the prepolymer to about 10 g/10 min. The obtained slurry together with prepolymerized catalyst and triethyl aluminium cocatalyst were transferred to the actual polymerization step, i.e. introduced into a 500 dm³ loop reactor, wherein a continuous feed of propane, ethylene and hydrogen was also introduced. The ratio of H2/C2 in the reaction mixture was 240 mol/kmol . 1-Butene was added to the loop reactor in the amount given in table 2 below. The loop reactor was operated at 95° C. temperature and 60 bar pressure. The process conditions were adjusted as shown in Table 2 to form polymer having an MFR₂ of 300 g/10 min and a density of about 951 kg/m³ at a production rate of about 30 kg/h.

The slurry was then transferred to a fluidized bed gas phase reactor, where also additional ethylene, 1-butene comonomer and hydrogen were added, together with nitrogen as an inert gas to produce the HMW component in the presence of the LMW component. The ratio of H2/C2 in the recycle gas was 7 mol/kmol and the ratio of C4/C2 was 460 mol/kmol. The gas phase reactor was operated at a temperature of 80° C. and a pressure of 20 bar. The production rate of the polymer was about 75 kg/h. The split (wt %) loop/gas phase was 41/59. The polymer obtained from the gas phase reactor had MFR₂ of 0.25 g/10 min and a density of about 922 kg/m³.

The reactor powder was then stabilized with conventional additives and pelletized in a known manner using CIM9OP counter-rotating twin screw extruder manufactured by Japan Steel Works. The product properties of the pelletized final polymers are given in table 2 below.

Example 4: znLLDPE 2 and Example 5: znLLDPE 3 were prepared according to the method described for znLLDPE 1, except the reaction conditions were adjusted in a known manner to provide polymers with desired properties. The polymerization conditions and polymer properties are given in table 2 below. In case of znLLDPE 2 comonomer, 1-butene, was added to the loop reactor in amounts as given in table 2 for producing LMW ethylene copolymer.

TABLE 2
Polymerisation conditions and the product properties of the obtained
products of example 3-5

| | Ex. 3 | Ex. 4 | Ex. 5 |
|---|---|---|---|
| Polymer | znLLDPE 1 | znLLDPE 2 | znLLDPE 3 |
| Ethylene concentration in loop | 6.7 | 6.4 | 6.8 |
| reactor, mol-% | | | |
| Hydrogen to ethylene ratio in | 240 | 235 | 350 |
| loop reactor, mol/kmol | | | |
| 1-butene to ethylene mole | 570 | 730 | — |
| ratio in loop reactor, | | | |
| mol/kmol | | | |
| Polymer production rate in | 30 | 28 | 30 |
| loop reactor, kg/h | | | |
| MFR₂ of polymer produced in | 300 | 300 | 300 |
| loop reactor, g/10 min | | | |
| Density of polymer produced | 951 | 946 | 972 |
| in loop reactor, kg/m³ | | | |
| Ethylene concentration in | 19 | 20 | 22 |
| gas phase reactor, | | | |
| mol-% | | | |
| Hydrogen to ethylene ratio | 7 | 4 | 8 |
| in gas phase reactor, | | | |
| mol/kmol | | | |
| 1-butene to ethylene mole | 460 | 580 | 450 |
| ratio in gas phase | | | |
| reactor, mol/kmol | | | |
| Polymer production rate | 75 | 75 | 75 |
| in gpr, kg/h | | | |
| Split, loop/gpr | 41/59 | 48/52 | 41/59 |
| MFR₂ of the pelletized final | 0.2 | 0.4 | 0.2 |
| polymer, g/10 min | | | |
| Density of the pelletized final | 923 | 924 | 931 |
| polymer, kg/m³ | | | |

Film Sample Preparation

Films having an ABC-structure were coextruded on a 3-layer Windmöller&Hölscher Varex coextrusion line with die diameter 200 mm, at a blow up ratio (BUR) of 1:3, frost line height 600 mm and Die gap 1.2 mm. The temperature settings on the three extruders were A=210° C. B=210° C./C=170° C. and the temperature setting on the extruder die was 200° C. The formed films have thicknesses as shown in Table 3 and the composition of each of the films is also presented in Table 3.

Stretching and lamination was carried out using a monodirectional stretching machine manufactured by Hosokawa Alpine AG in Augsburg/Germany. The film obtained from blown film extrusion was pulled into the orientation machine and heated by passing it over several heating rollers. These rollers have a temperature of 110-120° C. and cause the inner C-layer(s) to melt and fully laminate the two films together and furthermore enable the film to be easily stretched. After passing the heating rollers the film has reached a homogenous temperature. The film is then stretched between two sets of nip rollers where the second pair runs at higher speed than the first pair resulting in the desired draw ratio. Stretching is carried out with the draw ratios presented in Table 3. After stretching the uniaxially oriented film was tempered to anneal by passing over a set of annealing rollers where the speed was reduced which results in a relaxation of the film stresses. At last the film was cooled by passing over chilled cooling rollers. After exiting the stretching machine the film is fed into a conventional film winder where the film is slit to its desired width and wound to form reels.

The mechanical properties of the films are shown in Table 4.

As to the film samples used in the determinations of general film properties as defined above in the description part:
The film samples ABCCBA used for determining the general film properties for heavy weight/duty applications up to e.g. 50 kg loads were prepared as described above and had ABC thickness before lamination of 240 μm, starting thickness of ABCCBA before stretching of 480 μm, draw ratio of 1:6, final thickness of 80 μm after stretching and a thickness distribution (%) of 20/22.5/7.5/7.5/22.5/20 of the total film thickness.
The film samples ABCCBA used for determining the film properties for said light weight applications up to e.g. 5 kg loads were prepared as described above and had ABC thickness before lamination of 165 μm, starting thickness of ABCCBA before stretching of 330 μm, draw ratio of 1:6, the final thickness of 55 μm after stretching and thickness distribution (%) of 15/27.5/7.5/7.5/27.5/15

TABLE 3

| | Composition | | | | | | | |
|---|---|---|---|---|---|---|---|---|
| Film | | | | Layer thickness | Initial film thickness | Laminated | | Final film thickness |
| No. | Layer (A) | Layer (B) | Layer (C) | distribution (%) | (μm) | Structure | Draw Ratio | (μm) |
| 1 | 70% | 100% | 100% EMA 1 | 40/45/15 | 240 | ABCCBA | 1:6.3 | 77 |
| | znLLDPE 1 | znLLDPE 1 | | | | | | |
| | 30% | | | | | | | |
| | mLLDPE 2 | | | | | | | |
| 2 | 70% | 100% | 100% EMA 1 | 30/55/15 | 180 | ABCCBA | 1:6.3 | 57 |
| | znLLDPE 1 | znLLDPE 1 | | | | | | |
| | 30% | | | | | | | |
| | mLLDPE 2 | | | | | | | |
| 3 | 100% | 100% | 100% EMA 2 | 40/45/15 | 240 | ABCCBA | 1:6 | 80 |
| | znLLDPE 1 | znLLDPE 3 | | | | | | |
| 4 | 50% | 100% | 100% EMA 2 | 40/45/15 | 240 | ABCCBA | 1:6 | 83 |
| | znLLDPE 1 | znLLDPE 3 | | | | | | |
| | 50% | | | | | | | |
| | mLLDPE 1 | | | | | | | |
| 5 | 100% | 100% | 100% EMA 2 | 40/45/15 | 255 | ABCCBA | 1:5.8 | 86 |
| | znLLDPE 1 | znLLDPE 3 | | | | | | |
| 6 | 100% | 100% | 100% EMA 2 | 40/40/20 | 275 | ABCCBA | 1:5.9 | 93 |
| | znLLDPE 1 | znLLDPE 3 | | | | | | |

TABLE 4
Film properties of the film examples

| | HDSS | | | | | | | |
|---|---|---|---|---|---|---|---|---|
| Property | specification# | Film 1 | Film 2 | Film 3 | Film 4 | Film 5 | Film 6 | CE1* |
| Thickness (μm) | 130 | 77 | 57 | 80 | 83 | 86 | 93 | 132 |
| Dart Drop | 550 | 920 | | 860 | 590 | 950 | 980 | 700 |
| Impact (DDI) | | | | | | | | |
| (g) | | | | | | | | |
| Relative DDI | 4.2 | 11.9 | | 10.8 | 7.1 | 11.0 | 10.5 | 5.3 |
| (g/μm) | | | | | | | | |
| Tear | 8 | 9.2 | 2.9 | 7.5 | 7.8 | 10.2 | 13.9 | 11 |
| Resistance/MD | | | | | | | | |
| (N) | | | | | | | | |
| Relative Tear | 61.5 | 119.5 | 50.9 | 93.8 | 94.0 | 118.6 | 159.5 | 83.3 |
| Resistance/MD | | | | | | | | |
| (N/mm) | | | | | | | | |
| Creep | 10 | | | 7 | 5 | 7.2 | 7.8 | |
| MD/23N/23° C. | | | | | | | | |
| (%) | | | | | | | | |

*Comparative example was commercially available packaging film for heavy duty applications, not stretched, and comprised 50 wt % of a unimodal LLDPE, MFR₂ of 1.3 g/10 min and density of 927 kg/m³ and 50 wt % of a bimodal znLLDPE, MFR₂ of 0.2 g/10 min and density of 931 kg/m³.
#HDSS specification lists typical demands given in the state of art for the film properties needed in heavy duty shipping sacks.

Further mechanical properties of Film 4 were determined and the results are shown in the Table 5 below.

TABLE 5

| | HDSS property | | Film 4 of the |
|---|---|---|---|
| | specification | CE1* | invention |
| Film thickness (μm) | 80 ± 5 | 132 | 83 |
| Tensile modulus | >250 | 310 | 520 |
| (Stiffness)/TD | | | (MD 480) |
| (MPa) | | | |

1-23. (canceled)

24. A uniaxially oriented multilayer film comprising at least (i) an outer layer (B) and (ii) an inner layer (C), wherein
said layer (B) (i) comprises a multimodal linear low density polyethylene (LLDPE),
said layer (C) (ii) comprises at least one polymer component which has a Tm≧100° C., and
said multilayer film is in the form of a stretched film which is uniaxially oriented in the machine direction (MD) in a draw ratio of at least 1:3.

25. The film as claimed in claim 24 in the form of a laminated multilayer film which comprises:
(a) at least said outer layer (B) and said inner layer (C) in the form of a multilayer film laminate, and
(b) a substrate,
wherein said inner layer (C) of said film laminate (a) is in contact with the surface of said substrate (b), and wherein said laminated multilayer film is uniaxially oriented in the machine direction (MD) in a draw ratio of at least 1:3.

26. The film as claimed in claim 25, wherein said substrate (b) comprises at least: (iii) an inner layer (C) comprising at least one polymer component which has a Tm≧100° C., and, optionally,
(iv) an outer layer (B).

27. The film as claimed in claim 25, comprising:
(i) a layer (B) and
(ii) a layer \textcircled{C}, in the form of a coextruded multilayer film as said film laminate (a),
and
(iii) a layer \textcircled{C} and
(iv) a layer (B), in the form of a coextruded multilayer film as said substrate (b),
wherein said coextruded laminate (a) and coextruded substrate (b) are laminated together.

28. The film as claimed in claim 24 comprising layers in the following order:
(i) layer (B),
(ii) layer (C),
(iii) layer (C) and
(iv) layer (B),
wherein layers (B) (i) and (B) (iv) and/or layers (C) (ii) and (C) (iii) comprise the same or different polymer composition(s), preferably at least layers (C) (ii) and (C) (iii) comprise the same polymer composition.

29. The film as claimed in claim 24 in the form of a stretched film which is uniaxially oriented in the MD in a draw ratio of 1:3 to 1:10.

30. The film as claim in claim 24, further comprising at least one layer (A).

31. The film as claimed in claim 30 comprising layers in the following order:
(i) a first outer layer (A),
(ii) a second outer layer (B) and
(iii) an inner layer (C).

32. The film as claimed in claim 31 comprising layers in the following order:
(i) a first outer layer (A),
(ii) a second outer layer (B),
(iii) a first inner layer (C),
(iv) a second inner layer \textcircled{C},
(v) a third outer layer (B) and
(vi) a fourth outer layer (A),

33. The film as claimed in claim 30, wherein the laminated film, comprises:
(i) an optional layer (A),
(ii) a layer (B) and
(iii) a layer (C) in the form of a coextruded multilayer film as said substrate (b), whereby said coextruded laminate (a) and coextruded substrate (b) are laminated together.

34. The film as claimed in claim 24, wherein layer (B) comprises multimodal LLDPE produced using a Ziegler Natta catalyst (znLLDPE).

35. The film as claimed in claim 24, wherein layer (C) comprises at least one ethylene acrylate copolymer.

36. The film as claimed in claim 24, wherein layer (C) comprises an ethylene alkyl acrylate, preferably ethylene methyl acrylate (EMA).

37. The film as claimed in claim 30, wherein layer (A) comprises a LLDPE selected from a multimodal znLLDPE, a unimodal mLLDPE, a multimodal mLLDPE or a mixture of multimodal znLLDPE and mLLDPE, which mLLDPE is a unimodal or multimodal mLLDPE, or a mixture thereof.

38. The film as claimed in claim 24 having a thickness of less than 140 μm.

39. A process for the preparation of a multilayer film comprising forming a film by extruding a composition (b) comprising a multimodal LLDPE, and a composition (c) comprising at least one polymer component which has a Tm≦100° C.,

40. The process as claimed in claim 39, wherein said stretching provides a draw ratio of 1:3 to 1:10, preferably 1:5 to 1:8.

41. The process as claimed in claim 39 for the preparation of a laminated multilayer film comprising:
extruding at least a composition (b) and a composition (c) to form a film laminate (a),
contacting said laminate with a substrate (b),
laminating said film laminate (a) and substrate (b), and
stretching the obtained laminated multilayer film in the MD.

42. The process as claimed in claim 41, wherein lamination is carried out at the same time as stretching.

43. A film produced by the process of claim 39.

44. An article comprising the film as claimed in claim 24.

45. The article as claimed in claim 44, wherein the article is a packaging article.
